(19) United States
(12) Patent Application Publication
(10) Pub. No.: US 2020/0016962 A1
(43) Pub. Date: Jan. 16, 2020

(54) ANTI-GLARE DEVICE AND CONTROLLER

(71) Applicant: KABUSHIKI KAISHA TOKAI RIKA DENKI SEISAKUSHO, Aichi (JP)

(72) Inventor: Taku NISHIKAWA, Aichi (JP)

(21) Appl. No.: 16/449,940

(22) Filed: Jun. 24, 2019

(30) Foreign Application Priority Data
Jul. 11, 2018 (JP) 2018-131253

(51) Int. Cl. B60J 3/02; B60J 3/00

(52) U.S. Cl. CPC B60J 3/0286; B60J 3/0278; B60J 3/007

(57) ABSTRACT

An anti-glare device includes a light shield of which light transmittance of irradiated light is changed; an illuminance detector that detects intensity of the irradiated light; a light-shield controller that controls light transmittance of the light shield based on a detection result of the illuminance detector; and a power controller that controls power supplied to the light-shield controller based on the detection result of the illuminance detector. The power controller reduces the power supplied to perform an anti-glare operation when the intensity of the irradiated light is low.

### BACKGROUND

### 1. Field

The present disclosure relates to an anti-glare device and a controller thereof.

### 2. Description of Related Art

A known anti-glare device reduces glare by decreasing irradiated light directed toward an occupant of a vehicle or the like. Japanese Laid-Open Patent Publication No. 2002-321529 discloses a sun visor that is one type of an anti-glare device. The sun visor disclosed in the publication includes a light shield that is tinted in accordance with the applied voltage to change the light transmission. The light shield is pivotal about a shaft and moved between a retracted position and a usage position. A contact goes on and off to allow for determination of whether the light shield is located at the retracted position or the usage position. The supply of power to the light shield is controlled based on the determination result.

### SUMMARY

A sun visor is desirable to be actuated (for example, powered on or off) in a manner suited for the intensity of irradiated light.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, a controller of an anti-glare device is provided. The controller includes a power controller that reduces, when intensity of irradiated light is low, power supplied to perform an anti-glare operation with the anti-glare device that changes light transmittance of irradiated light to reduce glare.

In another aspect, the controller of an anti-glare device includes a light-shield controller that compares a first intensity indicating intensity of light irradiated from one side with a second intensity indicating intensity of light irradiated from an opposite side and controls the light transmittance based on one of the first intensity and the second intensity having a greater intensity.

In one aspect, an anti-glare device is provided. The anti-glare device includes a light shield of which light transmittance of irradiated light is changed; an illuminance detector that detects intensity of the irradiated light; a light-shield controller that controls light transmittance of the light shield based on a detection result of the illuminance detector; and a power controller that controls power supplied to the light-shield controller based on the detection result of the illuminance detector to reduce the power supplied to perform an anti-glare operation when the intensity of the irradiated light is low.

In another aspect, the anti-glare device includes a light shield that changes light transmittance of irradiated light and includes a first surface and an opposite second surface; a first illuminance detector that detects intensity of irradiated light striking the first surface of the light shield and outputs a first detection result; a second illuminance detector that detects intensity of irradiated light striking the second surface of the light shield and outputs a second detection result; and a light-shield controller that compares the first detection result with the second detection result and controls the light transmittance of the light shield based on one of the first detection result and the second detection result indicating a greater intensity.

Other features and aspects will be apparent from the following detailed description, the drawings, and the claims.

### BRIEF DESCRIPTION OF THE DRAWINGS

FIG. 1A is a side view illustrating a sun visor according to a first embodiment.

FIG. 1B is a front view illustrating the sun visor of FIG. 1A.

FIG. 2 is a block diagram illustrating the electric configuration of the sun visor according to the first embodiment.

FIG. 3 is a flowchart illustrating an anti-glare operation of the sun visor performed in cooperation with power control in the first embodiment.

FIG. 4 is a side view illustrating the sun visor according to the first embodiment in a usage state and a non-usage state.

FIG. 5 is a side view illustrating a sun visor according to a second embodiment.

FIG. 6 is a block diagram illustrating the electric configuration of the sun visor according to the second embodiment.

FIG. 7 is a flowchart illustrating an anti-glare operation of the sun visor performed in cooperation with power control in the second embodiment.

FIG. 8 is a side view illustrating the sun visor according to the second embodiment in a usage state and a non-usage state.

FIG. 9 is a diagram illustrating the sun visor in a front usage state and a side usage state.

FIG. 10 is a block diagram illustrating the electric configuration of a sun visor according to a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

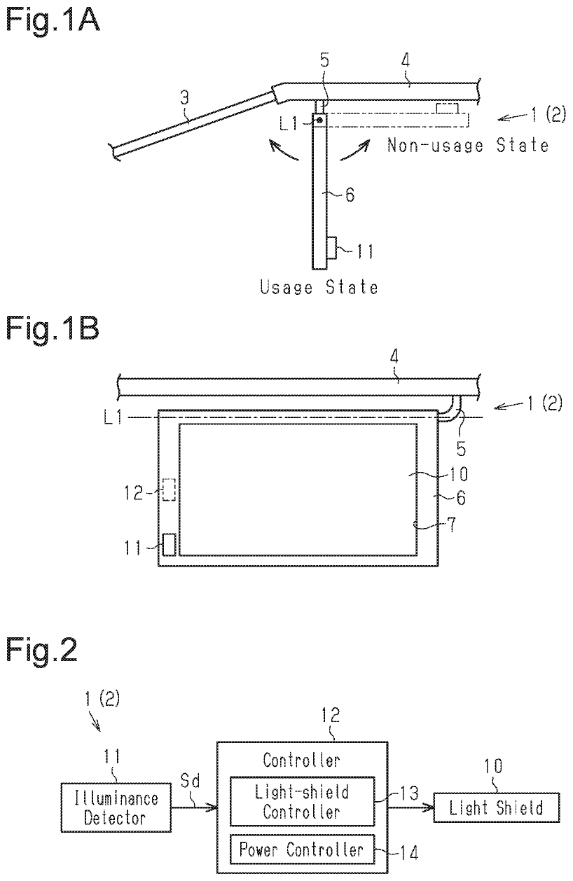

An anti-glare device and a controller thereof according to a first embodiment will now be described with reference to FIGS. 1A to 4.

As illustrated in FIG. 1A, an anti-glare device 1, which refers to a sun visor 2 in the present example, is arranged near a windshield glass 3 inside a vehicle. As illustrated in FIG. 1B, the sun visor 2 includes a support body 6 pivotally attached to a support shaft 5 suspended from a ceiling 4 of the vehicle.

The support body 6 is flat and includes a rectangular opening 7. The sun visor 2 includes an anti-glare light shield 10 attached integrally to the opening 7 of the support body 6 to reduce (block) the light directed toward the occupant of a vehicle. The light transmittance of the light shield 10 is changed in accordance with an applied voltage to block the irradiated light. The light shield 10 includes an electrochromic element that is tinted (light transmittance is lowered), for example, in accordance with the applied voltage. The light shield 10 can be used as a transparent display when voltage is not applied.

The support body 6 is configured to pivot about an axis L1 of the support shaft 5 between a position proximate to the windshield glass 3 and a position proximate to the ceiling 4. When the support body 6 is proximate to the ceiling 4, the light shield 10 (sun visor 2) is in a non-usage state and thereby does not block irradiated light. When the support body 6 is moved away from the ceiling 4, the light shield 10 is in a usage state and thereby blocks the irradiated light.

The sun visor 2 includes an illuminance detector 11 that detects the received light intensity of the irradiated light. The illuminance detector 11 may include, for example, a known illuminance detector. The illuminance detector 11 generates a detection signal Sd in accordance with the detected received light intensity. The output value of the detection signal Sd increases as the received light intensity increases (becomes brighter) and decreases as the received light intensity decreases (becomes darker). The illuminance detector 11 is arranged on the support body 6 to be located at a position opposed to the ceiling 4 when the sun visor 2 is in the non-usage state.

As illustrated in FIG. 1B, the sun visor 2 includes a controller 12 that controls the anti-glare operation of the sun visor 2. In the present example, the controller 12 is arranged in the support body 6.

As illustrated in FIG. 2, the controller 12 includes a light-shield controller 13 that controls the light transmittance of the light shield 10 based on a detection signal Sd of the illuminance detector 11. In the present example, the light-shield controller 13 changes the light transmittance of the light shield 10 by changing the voltage applied to the light shield 10. The light-shield controller 13 increases the voltage applied to the light shield 10 and lowers the light transmittance of the light shield 10 as the output value of the detection signal Sd of the illuminance detector 11 rises.

The controller 12 includes a power controller 14 that reduces the power supplied to perform an anti-glare operation when the intensity of the irradiated light is low. The power controller 14 controls the power supplied from a power supply (not illustrated) to the light-shield controller 13 based on the detection signal Sd of the illuminance detector 11. For example, if the detection signal Sd of the illuminance detector 11 is less than or equal to a threshold, the power controller 14 stops (prohibits) the supply of power to the light-shield controller 13.

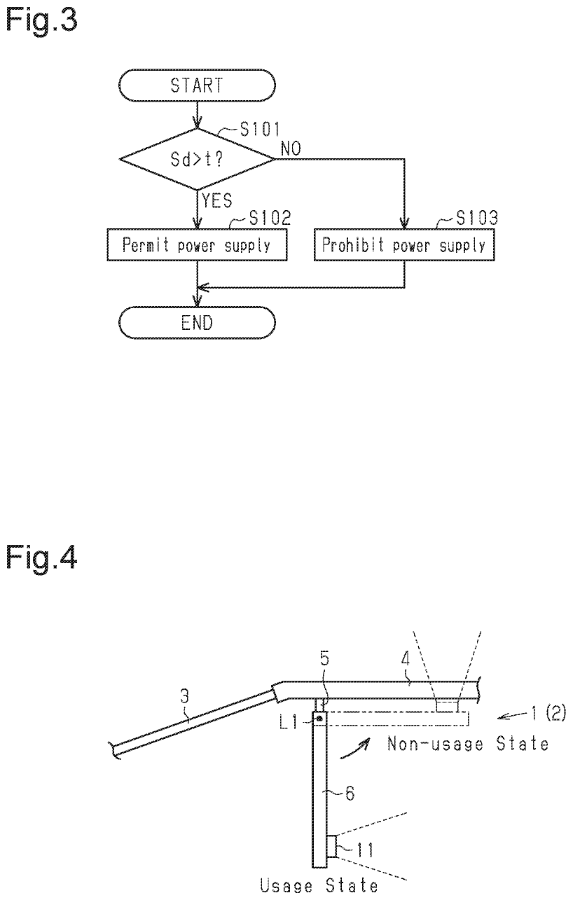

The operation and advantages of the sun visor 2 according to the first embodiment will now be described with reference to FIGS. 3 and 4. The anti-glare operation of the sun visor 2, which is performed in cooperation with the power control executed by the power controller 14, will now be described.

As illustrated in FIG. 3, in step S101, the power controller 14 determines whether the output value of the detection signal Sd of the illuminance detector 11 is greater than a threshold t. If the detection signal Sd is greater than the threshold t, the power controller 14 proceeds to step S102. If the detection signal Sd is less than or equal to the threshold t, the power controller 14 proceeds to step S103.

In step S102, the power controller 14 permits the supply of power to the light-shield controller 13. The light-shield controller 13 controls the light transmittance of the light shield 10 in accordance with the detection signal Sd of the illuminance detector 11 to perform an anti-glare operation.

In step S103, the power controller 14 stops (prohibits) the supply of power to the light-shield controller 13. In this manner, if the intensity of the irradiated light is low, that is, if the irradiated light is dark, the supply of power to the light-shield controller 13 is stopped. This decreases the power consumed by the sun visor 2, thereby actuating the sun visor 2 in a manner suited for the intensity of the irradiated light.

As illustrated in FIG. 4, the light shield 10 of the sun visor 2 selectively takes a usage state, in which the light shield 10 blocks the irradiated light, and a non-usage state, in which the light shield 10 does not block the irradiated light. When the light shield 10 is in the non-usage state, the sun visor 2 is not used by the occupant. Thus, it is preferred that the power supplied to the sun visor 2 to perform the anti-glare operation be reduced in the non-usage state. In the present example, the illuminance detector 11 on the support body 6 is located at a position opposed to the ceiling 4 when in the non-usage state. Thus, the output value of the detection signal Sd of the illuminance detector 11 is smaller in the non-usage state than that in the usage state. This is because the ceiling 4 blocks the light reception range of the illuminance detector 11 in the non-usage state as illustrated by the broken lines in FIG. 4. In this manner, the illuminance detector 11 is located at a position where the received light intensity will be low in the non-usage state so that the detection signal Sd will be less than or equal to the threshold t when the sun visor 2 is in the non-usage state. This allows the power controller 14 to stop (prohibit) the supply of power to the light-shield controller 13.

The anti-glare device 1 according to the first embodiment has the advantages described below.

In the present example, the controller 12 of the anti-glare device 1 includes the power controller 14 that reduces the power supplied to perform the anti-glare operation when the intensity of the irradiated light is low. This configuration reduces the supply of power based on the intensity of the irradiated light. Thus, the anti-glare device 1 is actuated in a manner suited for the intensity of the irradiated light.

In the present example, in addition to the power controller 14, the anti-glare device 1 includes the illuminance detector 11, which detects the intensity of the irradiated light, and the light-shield controller 13, which controls the light transmittance of the light shield 10. With this configuration, the power controller 14 controls the supply of power based on the output value of the detection signal Sd of the illuminance detector 11. Thus, the anti-glare device 1 is actuated in a manner suited for the intensity of the irradiated light.

In the present example, the illuminance detector 11 is arranged on the support body 6 that supports the light shield 10. With this configuration, the illuminance detector 11 is arranged in the proximity of the light shield 10 to allow for easy detection of the intensity of the irradiated light striking the light shield 10. This is advantageous for actuating the anti-glare device 1 in a manner suited for the intensity of the irradiated light.

In the present example, the light shield 10 selectively takes a usage state, in which the light shield 10 blocks the irradiated light, and a non-usage state, in which the light shield 10 does not block the irradiated light. The illuminance detector 11 is located at a position where the intensity of the irradiated light will be lower when the light shield 10 is in the non-usage state than in the usage state. With this configuration, the intensity of the irradiated light detected by the illuminance detector 11 differs between the usage state and the non-usage state. Thus, the determination of whether the light shield 10 is in the usage state or the non-usage state can be easily performed based on the intensity of the irradiated light. This is further advantageous for actuating the anti-glare device 1 in a manner suited for the intensity of the irradiated light.

### Second Embodiment

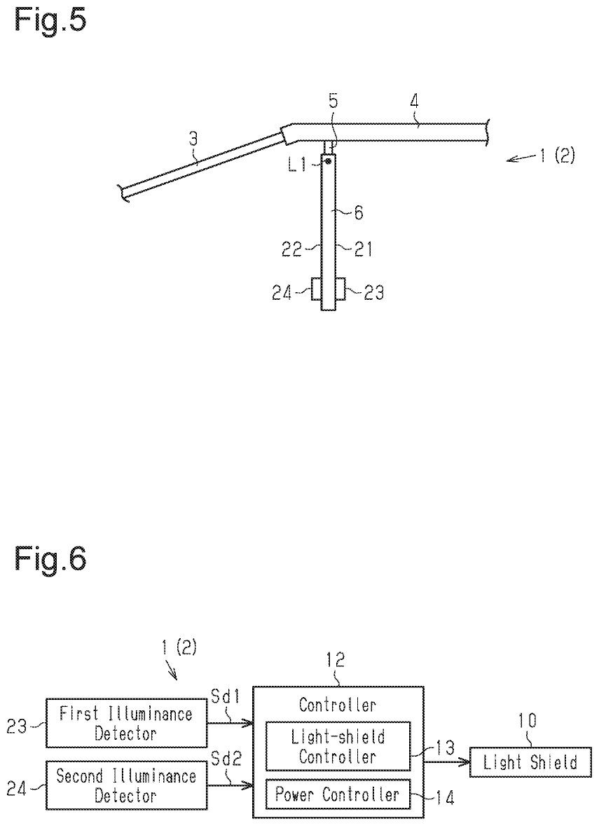

An anti-glare device and a controller according to a second embodiment will now be described with reference to FIGS. 5 to 8. The second embodiment mainly differs from the first embodiment in that the anti-glare device 1 (sun visor 2 in the present example) includes a plurality of illuminance detectors. Thus, same reference numerals are given to those components that are the same as the corresponding components of the first embodiment. Such components will not be described in detail. The description hereafter will focus on differences from the first embodiment.

As illustrated in FIG. 5, the light shield 10 includes a first surface 21 and a second surface 22 at the side opposite to the first surface 21. The first surface 21 is opposed to the ceiling 4 when the light shield 10 is in the non-usage state, and the second surface 22 is opposed to the windshield glass 3 when the light shield 10 is in the usage state.

The sun visor 2 includes a first illuminance detector 23 that detects the received light intensity of the irradiated light striking the first surface 21 of the light shield 10. The sun visor 2 also includes a second illuminance detector 24 that detects the received light intensity of the irradiated light striking the second surface 22 of the light shield 10. The first illuminance detector 23 is arranged on the support body 6 at the same side as the first surface 21 of the light shield 10. The second illuminance detector 24 is arranged on the support body 6 at the same side as the second surface 22 of the light shield 10.

As illustrated in FIG. 6, the first illuminance detector 23 outputs a detection signal Sd1 to the controller 12 in accordance with the received light intensity of the irradiated light. The second illuminance detector 24 outputs a detection signal Sd2 to the controller 12 in accordance with the received light intensity of the irradiated light.

The power controller 14 controls the power supplied to the light-shield controller 13 based on the one of the detection signals Sd1 and Sd2 indicating a lower received light intensity. If the light shield 10 (sun visor 2) is in the non-usage state, the first illuminance detector 23 is covered by the ceiling 4 so that the detection signal Sd1 of the first illuminance detector 23 indicates a lower intensity than the detection signal Sd2 of the second illuminance detector 24. This allows the power controller 14 to determine that the light shield 10 (sun visor 2) is in the non-usage state based on the output value of the detection signal Sd1. For example, if the one of the detection signals Sd1 and Sd2 indicating a lower intensity is less than or equal to a threshold t1, the power controller 14 stops (prohibits) the supply of power to the light-shield controller 13.

If power is supplied to the light-shield controller 13, the light-shield controller 13 controls the light transmittance of the light shield 10 based on the one of the detection signals Sd1 and Sd2 indicating a greater intensity. For example, the light-shield controller 13 increases the voltage applied to the light shield 10 to lower the light transmittance of the light shield 10 as the output value of the one of the detection signals Sd1 and Sd2 indicating a greater intensity rises.

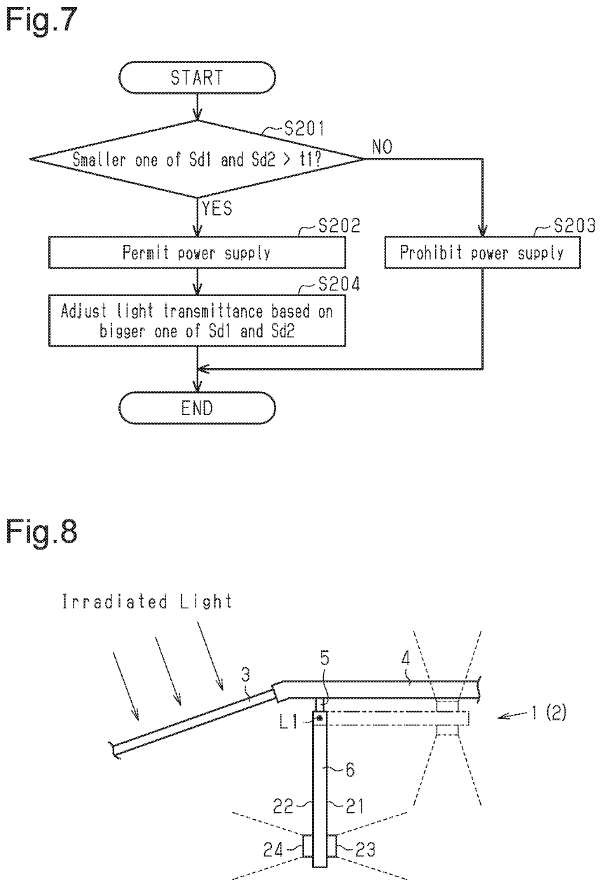

The operation and advantages of the sun visor 2 according to the second embodiment will now be described with reference to FIGS. 7 and 8.

As illustrated in FIG. 7, in step S201, the power controller 14 determines whether the one of the detection signals Sd1 and Sd2 indicating a lower intensity is greater than the threshold t1. If the one of the detection signals Sd1 and Sd2 indicating a lower intensity is greater than the threshold t1, the power controller 14 proceeds to step S202. If the one of the detection signals Sd1 and Sd2 having a lower intensity is less than or equal to the threshold t1, the power controller 14 proceeds to step S203.

In step S202, the power controller 14 permits the supply of power to the light-shield controller 13. This allows the light transmittance of the light shield 10 to be controlled when the light shield 10 is in the usage state.

In step S203, the power controller 14 stops (prohibits) the supply of power to the light-shield controller 13.

In step S204, the light-shield controller 13 controls the light transmittance of the light shield 10 based on the one of the detection signals Sd1 and Sd2 having a greater intensity.

As illustrated in FIG. 8, in the non-usage state, the first illuminance detector 23 is located at a position opposed to the ceiling 4 so that the detection signal Sd1 of the first illuminance detector 23 will be smaller than the detection signal Sd2 of the second illuminance detector 24. In this case, the power controller 14 controls the supply of power to the light-shield controller 13 based on the detection signal Sd1. When the output value of the detection signal Sd1 is less than or equal to the threshold t1 in the non-usage state, the power controller 14 stops the supply of power to the light-shield controller 13.

When the sun visor 2 is in the usage state to reduce glare of the irradiated light passing through the windshield glass 3, the second illuminance detector 24 receives the irradiated light. In this case, the output value of the detection signal Sd2 of the second illuminance detector 24 is greater than that of the detection signal Sd1 of the first illuminance detector 23. Thus, the light-shield controller 13 controls the light transmittance of the light shield 10 based on the detection signal Sd2. This reduces the glare dazzling of the occupant.

The anti-glare device 1 according to the second embodiment has the advantages described below.

In the present example, the anti-glare device 1 includes the first illuminance detector 23 and the second illuminance detector 24. Based on the detection result of the first illuminance detector 23 and the second illuminance detector 24, the power controller 14 controls the supply of power and the light-shield controller 13 controls the light transmittance. With this configuration, the first illuminance detector 23 detects irradiated light that is directed toward one side of the light shield 10, and the second illuminance detector 24 detects irradiated light that is directed toward the opposite side of the light shield 10. Thus, the supplied power and the light transmittance are controlled based on the comparison of the intensity of irradiated light in different directions. This is further advantageous for actuating the anti-glare device 1 in a manner suited for the intensity of the irradiated light.

In the present example, the power controller 14 controls the supply of power based on the one of the detection signals Sd1 and Sd2 indicating a lower intensity. With this configuration, the power of the light-shield controller 13 is switched on and off based on the irradiated light having a lower intensity. This appropriately switches the power on and off even when detecting irradiated light in different directions. Further, the light-shield controller 13 controls the light transmittance based on the one of the detection signals Sd1 and Sd2 having a greater intensity. With this configuration, the light transmittance of the light shield 10 is changed based on the irradiated light having a greater intensity so that glare is appropriately reduced. This is further advantageous for actuating the anti-glare device 1 in a manner suited for the intensity of the irradiated light.

### Third Embodiment

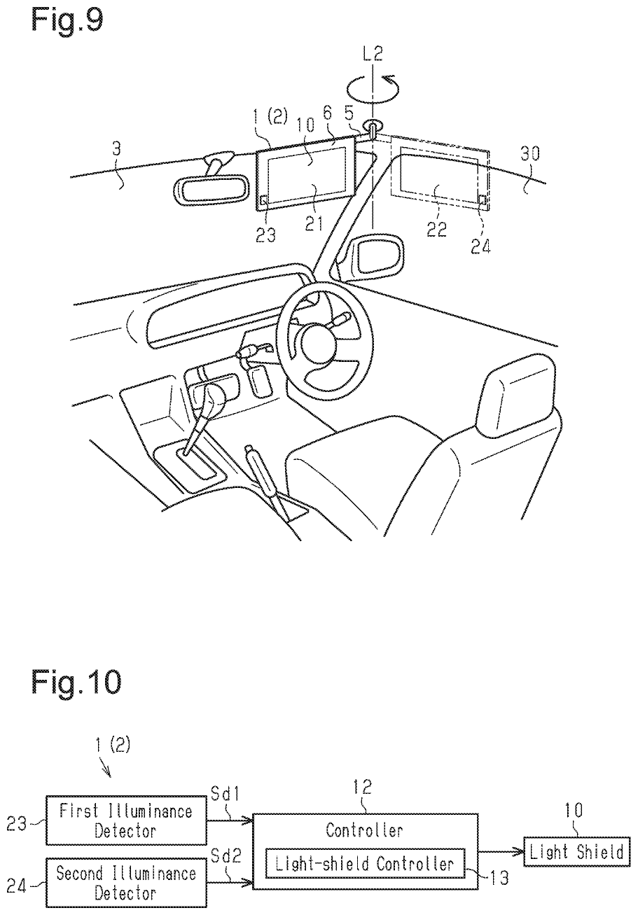

An anti-glare device and a controller according to a third embodiment will now be described with reference to FIGS. 9 and 10. Same reference numerals are given to those components that are the same as the corresponding components of the first and second embodiments. Such components will not be described in detail. The description hereafter will focus on differences from the first and second embodiments.

In addition to reducing glare of the irradiated light entering the vehicle through the windshield glass 3, the anti-glare device 1 according to the third embodiment may also be used as a side visor that reduces glare of the irradiated light entering the vehicle through a door glass (front door glass) located beside the driver seat.

As illustrated in FIG. 9, the anti-glare device 1, which serves as the sun visor 2 in the present example, is pivotal about an axis L2 of the support shaft 5. The sun visor 2 is pivoted about the axis L2 selectively to a front usage state, in which the sun visor 2 reduces the glare of irradiated light entering the vehicle through the windshield glass 3, and a side usage state, in which the sun visor 2 reduces the glare of irradiated light enters the vehicle through a door glass 30.

In the present example, when the light shield 10 is in the side usage state, the first surface 21 is opposed to the door glass 30. When the light shield 10 is in the front usage state, the second surface 22 is opposed to the windshield glass 3. In the same manner as the second embodiment, the sun visor 2 includes the first illuminance detector 23 that detects the irradiated light striking the first surface 21 of the light shield 10 and the second illuminance detector 24 that detects the irradiated light striking the second surface 22 of the light shield 10.

As illustrated in FIG. 10, the first illuminance detector 23 outputs a detection signal Sd1 to the controller 12 in accordance with the received light intensity that has been detected. The second illuminance detector 24 outputs a detection signal Sd2 to the controller 12 in accordance with the received light intensity that has been detected. The light-shield controller 13 of the controller 12 controls the light transmittance of the light shield 10 based on the one of the detection signals Sd1 and Sd2 indicating a greater intensity.

The operation and advantages of the sun visor 2 according to the third embodiment will now be described with reference to FIG. 9.

As illustrated in FIG. 9, when the sun visor 2 is in the front usage state to reduce glare of the irradiated light entering the vehicle through the windshield glass 3, the second illuminance detector 24 is directed toward the irradiated light. Thus, the detection signal Sd2 of the second illuminance detector 24 is greater than the detection signal Sd1 of the first illuminance detector 23, and the light-shield controller 13 controls the light transmittance based on the detection signal Sd2. This reduces glare of the irradiated light entering the vehicle through the windshield glass 3.

Further, when the sun visor 2 is in the side usage state to reduce glare of the irradiated light entering the vehicle through the door glass 30, the first illuminance detector 23 is directed toward the irradiated light. Thus, the detection signal Sd1 of the first illuminance detector 23 is greater than the detection signal Sd2 of the second illuminance detector 24, and the light-shield controller 13 controls the light transmittance based on the detection signal Sd1. This reduces glare of the irradiated light entering the vehicle through the door glass 30. The sun visor 2 may serve as a side visor in this manner.

The anti-glare device 1 according to the third embodiment has the advantages described below.

In the present example, the controller 12 of the anti-glare device 1 includes the light-shield controller 13. The light-shield controller 13 compares a first intensity, which indicates the intensity of light irradiating one side, with a second intensity, which indicates the intensity of the light irradiating the opposite side. Then, the light-shield controller 13 controls the light transmittance based on the one of the first intensity and the second intensity having a greater intensity. With this configuration, the light-shield controller 13 controls the light transmittance based on the irradiated light having a greater intensity. This allows the anti-glare device 1 to be actuated in a manner suited for the intensity of irradiated light. Further, the anti-glare device 1 may be used as a side visor.

In the present example, the anti-glare device 1 includes the first illuminance detector 23 and the second illuminance detector 24. The light-shield controller 13 controls the light transmittance of the light shield 10 based on the one of the detection signal Sd1 and the detection signal Sd2 indicating a greater intensity from the detection result of the first illuminance detector 23 and the second illuminance detector 24. With this configuration, the light transmittance of the light shield 10 is controlled using the detection signal Sd1 or the detection signal Sd2. This allows the anti-glare device 1 to be actuated in a manner suited for the intensity of the irradiated light. Further, the anti-glare device 1 may be used as a side visor.

The above embodiments may be modified and implemented as described below. The above embodiments and the following modifications may be implemented in combination as long as there are no technical contradictions.

In the above embodiments, the illuminance detector 11, the first illuminance detector 23, and the second illuminance detector 24 do not have to be arranged on the support body 6 and may be arranged on the light shield 10.

In the above embodiments, the illuminance detector 11, the first illuminance detector 23, and the second illuminance detector 24 may be located at positions separated from the light shield 10 as long as the received light intensity of irradiated light striking the light shield 10 can be detected. However, it would be advantageous if the detectors are arranged on the light shield 10 or the support body 6 since the light striking the light shield 10 can be easily detected.

In the above embodiments, the mechanism for changing the light transmittance of the light shield 10 is not particularly limited. The electrochromic element may be replaced with a photochromic element, a transmissive liquid crystal element, or the like as the mechanism for changing the light transmittance.

In the first and second embodiments, the switching between a usage state and a non-usage state does not have to be performed by a pivotal movement about the axis L1. For example, a usage state and a non-usage state may be switched by the light shield 10 by linearly moving (sliding) the support body 6 back and forth. When sliding the light shield 10, the illuminance detector 11 (or first illuminance detector 23) is arranged at a position where the intensity of the irradiated light detected by the illuminance detector 11 (or first illuminance detector 23) will be lower in a non-usage state as another member blocks the light reception range of the illuminance detector 11 (or first illuminance detector 23).

In the above embodiments, the power controller 14 and the light-shield controller 13 do not have to be arranged in the controller 12. The power controller 14 and the light-shield controller 13 may be separately arranged in different controllers or may be arranged in the light shield 10. Further, the power controller 14 and the light-shield controller 13 may be arranged in a controller provided separately from the anti-glare device 1 (sun visor 2).

In the first and second embodiments, the power controller 14 does not have to use the threshold t (or threshold t1) to execute the control that reduces the power supply. Further, the threshold t (or threshold t1) may be changed.

In the first and second embodiments, the power controller 14 does not have to stop (prohibit) the power supplied to perform an anti-glare operation and may instead reduce the supplied power.

In the above embodiments, the method for supplying power to the sun visor 2 is not limited. Power may be supplied from a vehicle battery or a battery installed in the sun visor 2.

In the above embodiments, the anti-glare device 1 is not limited to the sun visor 2 that is installed in a vehicle and may be applied to various types of anti-glare devices.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller of an anti-glare device, the controller comprising:
a power controller that reduces, when intensity of irradiated light is low, power supplied to perform an anti-glare operation with the anti-glare device that changes light transmittance of irradiated light to reduce glare.

2. An anti-glare device, comprising:
a light shield that changes light transmittance of irradiated light;
an illuminance detector that detects intensity of the irradiated light;
a light-shield controller that controls light transmittance of the light shield based on a detection result of the illuminance detector; and
a power controller that controls power supplied to the light-shield controller based on the detection result of the illuminance detector to reduce the power supplied to perform an anti-glare operation when the intensity of the irradiated light is low.

3. The anti-glare device according to claim 2, further comprising:
a support body that supports the light shield,
wherein the illuminance detector is arranged on one of the light shield and the support body.

4. The anti-glare device according to claim 3, wherein
the light shield is arranged to be selectively take a usage state at a position where the light shield blocks the irradiated light and a non-usage state at a position where the light shield does not block the irradiated light, and
the illuminance detector is located at a position where the intensity of the irradiated light is lower when the light shield is in the non-usage state than in the usage state.

5. The anti-glare device according to claim 2, wherein
the illuminance detector includes
a first illuminance detector that detects intensity of irradiated light striking a first surface of the light shield and outputs a first detection result, and
a second illuminance detector that detects intensity of irradiated light striking a second surface of the light shield at a side opposite to the first surface and outputs a second detection result,
the power controller controls the power supplied to the light-shield controller based on the first detection result and the second detection result, and
the light-shield controller controls the light transmittance of the light shield based on the first detection result and the second detection result.

6. The anti-glare device according to claim 5, wherein
the power controller controls the power supplied to the light-shield controller based on one of the first detection result and the second detection result indicating a lower intensity, and
the light-shield controller controls the light transmittance of the light shield based on one of the first detection result and the second detection result indicating a greater intensity.

7. A controller of an anti-glare device, the controller comprising:
a light-shield controller that compares a first intensity indicating intensity of light irradiated from one side with a second intensity indicating intensity of light irradiated from an opposite side and controls light transmittance in the anti-glare device based on one of the first intensity and the second intensity having a greater intensity.

8. An anti-glare device, comprising:
a light shield that changes light transmittance of irradiated light and includes a first surface and a second surface at a side opposite to the first surface;
a first illuminance detector that detects intensity of irradiated light striking the first surface of the light shield and outputs a first detection result;
a second illuminance detector that detects intensity of irradiated light striking the second surface of the light shield and outputs a second detection result; and
a light-shield controller that compares the first detection result with the second detection result and controls the light transmittance of the light shield based on one of the first detection result and the second detection result indicating a greater intensity.
